(19) United States
(12) Patent Application Publication
(10) Pub. No.: US 2026/0276586 A1
(43) Pub. Date: Sep. 17, 2026

(54) DIFFERENTIAL MOBILITY SPECTROMETER AND ANALYSIS METHOD

(71) Applicant: THE UNIVERSITY OF LIVERPOOL, Liverpool (GB)

(72) Inventors: Baris AKBALI, Liverpool (GB); Cedric BOISDON, Liverpool (GB); Royston GOODACRE, Liverpool (GB); Simon MAHER, Liverpool (GB)

(21) Appl. No.: 19/167,527

(22) PCT Filed: Mar. 27, 2024
(86) PCT No.: PCT/GB2024/050824

§ 371 Date: Sep. 22, 2025

(30) Foreign Application Priority Data
Mar. 31, 2023 (GB) 2304891.1

(51) Int. Cl. G01N 27/622

(52) U.S. Cl. CPC G01N 27/622

(57) ABSTRACT

An apparatus (1) including: a differential mobility separation, DMS, device (11) comprising: a set of mutually spaced apart electrodes (111), including a first electrode (111A) and a second electrode (111B) having a region R therebetween; a DC power supply (112) (not shown) configured to apply respective DC potentials to the set of electrodes (111) to provide an electric field E in the region R; a gas G source arranged to provide a flow F of gas G in the region R transverse, preferably orthogonal, to the electric field E; and an ion inlet (113) disposed to introduce ions I into the region R, wherein the ions I are mutually spatially separated in the flow F of the gas G according to their respective differential gas phase ion mobilities by the electric field E and wherein the mutually spatially separated ions S are correspondingly deposited on the first electrode (111A) as respective mutually spatially separated analytes A; and wherein the DMS device (11) comprises an interface (114) to an analyser (115) for analysis of the mutually spatially separated analytes A deposited on the first electrode (111A).

### FIELD

The present invention relates to differential mobility separation.

### BACKGROUND TO THE INVENTION

Across many fields, for example chemical synthesis/preparation, reaction monitoring, and analytical science, there is a universal need to characterise a variety of analytes. Analytes may be pure but more often are crude, that is comprising intricate mixtures of several different species. Therefore, there is a need to improve apparatus and methods of analysis of intricate analytes.

Raman spectroscopy is a well-known method for characterising analytes. The basic mode of operation of Raman spectroscopy involves illuminating a sample with a monochromatic light and collecting the inelastic portion of the scattered light. The scattered light is then analysed using a spectrometer to obtain a Raman spectrum, which represents the intensity of the scattered light as a function of the Raman shift. The Raman spectrum contains information about the different vibrational modes of the molecules in the sample, including their frequencies, intensities, and linewidths, which can be used to identify and characterize the sample.

Raman spectroscopy advantageously offers relatively high specificity, which allows for the identification and characterization of different chemical compounds in a given sample comprising a mixture of multiple analytes. Raman spectroscopy has limitations, for example, in terms of sensitivity, as it requires high laser powers to generate a detectable Raman signal, which can cause sample damage and fluorescence. The practical detection range seldomly works below 1% and usually only informs about the presence of a specific chemical bond.

There is a need to improve analytical characterisation of analytes. An object of the present invention is the provision of a process comprising at least 2 fundamentally different analytical techniques arranged in a complementary manner in a sequential arrangement.

Typically, the examination of intricate samples in a liquid state requires the isolation of a specimen and then determining and measuring the individual substances present within it. Commonly employed methods for separating substances during analysis include but are not limited to liquid chromatography (LC), gas chromatography (GC), and capillary zone electrophoresis (CZE). These separation techniques can be conveniently integrated with different chemical detection technologies, including but not limited to microfluidic devices, UV-visible and fluorescence spectroscopy, as well as mass spectrometry (MS).

Mass spectrometry (MS) is well-known method for characterising analytes. Mass spectrometry can present challenges, such as the necessity to ionize the molecule, the effects of ion suppression, inadequate differentiation between isobaric compounds, and the need to derivatize certain complex samples. MS requires certain ancillary subsystems, such as a vacuum system, that tend to increase its relative size, cost and complexity. These challenges may at times restrict the utility of this technique for characterization purposes.

Alternatively, vibrational spectroscopic techniques, for example infrared (IR) and Raman, can also function as detectors for high-performance liquid chromatography (HPLC) analyses. These techniques advantageously may furnish comprehensive structural data that enables definitive identification of analytes. Additionally, they also may offer comparably small and cost-effective instrumentation, as opposed to mass spectrometry (MS) and nuclear magnetic resonance (NMR) spectroscopy.

### SUMMARY OF THE INVENTION

It is one aim of the present invention, amongst others, to provide an apparatus and a method which partially obviate or mitigate at least some of the disadvantages of the prior art, whether identified herein or elsewhere. For instance, it is an aim of embodiments of the invention to provide an apparatus that improves analytical selectivity, sensitivity and/or limits of detection. For instance, it is an aim of embodiments of the invention to provide a method that improves analytical selectivity, sensitivity and/or limits of detection. An auxiliary benefit may reduce sample preparation requirements and enable analysis of compounds not typically amenable to chromatography.

A first aspect provides an apparatus including:
a differential mobility separation, DMS, device comprising:
a set of mutually spaced apart electrodes, including a first electrode and a second electrode having a region therebetween; a DC power supply configured to apply respective DC potentials to the set of electrodes to provide an electric field in the region; a gas source arranged to provide a flow of gas in the region transverse, preferably orthogonal, to the electric field; and an ion inlet disposed to introduce ions into the region, wherein the ions are mutually spatially separated in the flow of the gas according to their respective differential gas phase ion mobilities by the electric field and wherein the mutually spatially separated ions are correspondingly deposited on the first electrode as respective mutually spatially separated analytes; and
wherein the DMS device comprises an interface to an analyser for analysis of the mutually spatially separated analytes deposited on the first electrode.

A second aspect provides a method of analysing a sample comprising analytes, the method comprising:
ionising the analytes to provide ions therefrom;
introducing the ions into a region having an electric field and a mutually transverse flow of a gas;
mutually spatially separating the ions in the flow of the gas according to their respective differential gas phase ion mobilities by the electric field;
correspondingly depositing the mutually spatially separated ions on an electrode as respective mutually spatially separated analytes; and
analysing the mutually spatially separated analytes deposited on the electrode.

### DETAILED DESCRIPTION OF THE INVENTION

According to the present invention there is provided an apparatus, as set forth in the appended claims. Also provided is a method. Other features of the invention will be apparent from the dependent claims, and the description that follows.

### Apparatus

The first aspect provides an apparatus including:
a differential mobility separation, DMS, device comprising:
a set of mutually spaced apart electrodes, including a first electrode and a second electrode having a region therebetween; a DC power supply configured to apply respective DC potentials to the set of electrodes to provide an electric field in the region; a gas source arranged to provide a flow of gas in the region transverse, preferably orthogonal, to the electric field; and an ion inlet disposed to introduce ions into the region, wherein the ions are mutually spatially separated in the flow of the gas according to their respective differential gas phase ion mobilities by the electric field and wherein the mutually spatially separated ions are correspondingly deposited on the first electrode as respective mutually spatially separated analytes; and
wherein the DMS device comprises an interface to an analyser for analysis of the mutually spatially separated analytes deposited on the first electrode.

In this way, the ions are mutually spatially separated using the DMS device, based on their respective differential gas phase ion mobilities, and deposited on the first electrode. The mutual spatial separation of the ions is preserved upon deposition (i.e. correspondingly deposited) on the first electrode. For example, the mutually spatially separated ions may be deposited in and/or as mutually spatially separated respective lines or bands on the first electrode. In this way, the mutually spatially separated analytes deposited on the first electrode may be, for example subsequently and/or simultaneously, analysed using the analyser via the interface. In this way, mixtures of ions may be mutually spatially separated, based on their respective differential gas phase ion mobilities, and the mutually spatially separated analytes deposited on the first electrode analysed, for example characterised, identified and/or quantified, using the analyser via the interface. In this way, analytical resolution is enhanced since the mixtures of ions are first mutually separated before analysis, enabling discrimination of analytes, for example, that would not otherwise be resolved using the analyser such as due to interferences, improving sensitivity (signal to noise ratio) and/or a limit of detection of the respective analytes of the analyser and/or eliminating the requirement to chromatographically separate the analytes before analysis using the analyser. Additionally and/or alternatively, by depositing the mutually spatially separated ions in and/or as mutually spatially separated respective lines or bands on the first electrode, the respective analytes are effectively integrated by accumulation on the first electrode, thereby increasing an amount thereof for analysis using the analyser and hence improving sensitivity and/or a limit of detection of the respective analytes.

In other words, the apparatus according to the first aspect provides a hyphenated analytical technique, synergistically combining or coupling the gas phase ion mobility separation of the ions, using the DMS device, (i.e. a first analytical technique) with analysis using the analyser (i.e. a second analytical technique). Particularly, the inventors have determined that this hyphenation is enabled by depositing the mutually spatially separated ions on the first electrode as respective mutually spatially separated analytes, thereby preserving the mutual spatial separation provided by the gas phase ion mobility separation, and analysing the mutually spatially separated analytes deposited on the first electrode. In this way, some or all of the mutually spatially separated analytes deposited on the first electrode may be analysed using the analyser, directly thereupon for example using surface-enhanced Raman scattering (SERS) spectroscopy and/or indirectly for example using matrix-assisted laser desorption/ionization (MALDI) mass spectrometry (MS). In contrast, conventional approaches to analysis of gas phase ion mobility separated ions are limited to analysis of selected gas phase ion mobility separated ions only: to ions having a selected ion mobility, for example, while requiring that the second analytical technique analyses ions. Hence, the apparatus according to the first aspect increases analyte coverage while expanding the types of analysers that may be coupled therewith.

The exciting possibilities of combining differential ion mobility separation with SERS, for example, in this way offers unrivalled analytical performance which cannot be achieved in isolation. Without wishing to overstate the prospects of this approach, there is genuine potential to make a similar impact with the apparatus according to the first aspect as liquid chromatography-mass spectrometry (LC-MS) has had over the last 50 years, to initiate a new paradigm and to elevate the capabilities of what can be achieved in the field of analytical science.

The present invention offers many advantages over traditional methods. For example, one advantage is that employing a spatial deposition technique allows for the simultaneous deposition of multiple analytes, providing a technique that is faster than convention DMS wherein a single species must be deposited in one given location. A further example is that no prior differential mobility knowledge is necessary in order to detect an unknown chemical species, providing a technique that is suitable for exploratory and/or discovery situation, for example, in-situ monitoring of active chemical reactions. A yet further example is that the present invention is advantageously suitable for the preparation of a differential mobility chromatogram for further analytical methods, such as Raman, fluorescence and/or atomic absorption spectrometry, which can be performed sequentially in any preferred order. Another example is that advantageously analytes which may not be amenable (for example, unstable) to traditional liquid phase chromatography may be analysed.

The present invention is not limited to the analysis of intricate and/or crude analytes and may also be applied to pure samples, for example, those which have undergone prior purification and/or separation methods that would be well known to the skilled person, for example centrifugation and/or solid-phase microextraction.

### DMS Device

The apparatus comprises the differential mobility separation, DMS, device (also known as differential mobility analyser, DMA). DMS devices and principles of operation thereof are known generally.

Generally, a conventional DMS device makes use of a fast gas stream perpendicular to a static or varying electric field, whereby ions (more generally, charged aerosol particles or ions), transported by the gas stream, of different gas phase ion mobilities undergo different trajectories in the electric field. This conventional DMS device may be considered analogous to an electric sector mass spectrometry analyser.

### Electrodes

The DMS device comprises the set of mutually spaced apart electrodes, including the first electrode and the second electrode having the region (i.e. a lumen, a gap) therebetween. It should be understood that the electrodes of the set thereof are electrically conductive and/or comprise electrically conductive surfaces (i.e. sufficiently electrically conductive to provide the electric field in the region), for example mutually opposed electrically conductive surfaces having the region therebetween. Suitable electrical conductors are known.

In one example, the set of mutually spaced apart electrodes comprises and/or consists of parallel plate electrodes, for example, wherein the first electrode and the second electrode are mutually parallel. In this way, the electric field in the region is uniform, for example axially and/or transversally with respect to the set of mutually spaced apart electrodes. In one example, the first electrode comprises and/or is a planar electrode, for example non-segmented or a segmented planar electrode. In one example, the second electrode comprises and/or is a planar electrode, for example non-segmented or a segmented planar electrode.

In one example, the set of mutually spaced apart electrodes comprises and/or consists of non-parallel plate electrode, for example, wherein the first electrode and the second electrode are mutually inclined such as mutually converging or mutually diverging. In this way, the electric field in the region is non-uniform, for example axially and/or transversally with respect to the set of mutually spaced apart electrodes. In this way, differential mobility separation of the ions may be controlled, for example to relatively increase or decrease mutual spatial separation thereof, for example selectively based on respective gas phase ion mobilities, compared with parallel plate electrodes.

In one example, the set of mutually spaced apart electrodes comprises and/or consists of segmented electrodes (also known as segmented array electrodes c.f. non-segmented electrodes), for example, wherein the first electrode and/or the second electrode are segmented electrodes. In this way, the electric field in the region may be uniform or non-uniform, for example axially and/or transversally with respect to the set of mutually spaced apart electrodes, depending, at least in part, on the respective DC potentials applied to the respective segments thereof. In one example, the first electrode comprises and/or is a segmented electrode, comprising a set of segments including a first segment and a second segment, and optionally, wherein the DC power supply is configured to apply respective DC potentials to the set of segments.

In one example, the set of mutually spaced apart electrodes comprises and/or consists of parallel plate, segmented electrodes, for example, wherein the first electrode and/or the second electrode are mutually parallel segmented electrodes.

### DC Power Supply

The DMS device comprises the DC power supply configured to apply the respective DC potentials to the set of electrodes to provide the electric field in the region. Suitable DC power supplies are known.

In one example, the DC power supply comprises and/or consists of a DC-only power supply. In this way, the respective DC potentials to the set of electrodes are DC-only potentials (c.f. AC potentials applied by an AC power supply).

In one example, the DMS device excludes (i.e. does not include) an AC power supply configured to apply respective AC potentials to the set of electrodes.

In one example, the DC power supply is configured to apply respective constant (i.e. non-time varying or non-pulsed) DC potentials to the set of electrodes to provide a static electric field in the region (i.e. the electric field is a static electric field, provided by the respective constant DC potentials applied to the set of electrodes).

In one example, the DC power supply is configured to apply respective pulsed (i.e. non-constant or time varying) DC potentials to the set of electrodes to provide a pulsed electric field in the region (i.e. the electric field is a pulsed electric field, provided by the respective pulsed DC potentials applied to the set of electrodes). It should be understood that the respective pulsed DC potentials applied to the set of electrodes change in magnitude (i.e. a voltage level) but are not reversed in polarity. In one example, the respective pulsed DC potentials comprise rectangular pulses, for example symmetric rectangular pulses such as a square wave or asymmetric rectangular pulses. In one example, the respective pulsed DC potentials pulse between a set of DC potentials, including a first DC potential such as 0 V and a second DC potential. In one example, the set of DC potentials includes P DC potentials, including the first DC potential and the second DC potential, wherein P is a natural number greater than or equal to 2, for example 2, 3, 4, 5, 6, 7, 8, 9, 10, or more. In this way, as P is increased, the electric field may be stepped.

In one example, the DC power supply is configured to apply scanning DC potentials to the set of electrodes to provide a scanning electric field in the region (i.e. the electric field is a scanning electric field, provided by the respective scanning DC potentials applied to the set of electrodes). It should be understood that the respective scanning DC potentials applied to the set of electrodes change in magnitude (i.e. a voltage level) but are not reversed in polarity. In this way, the electric field may be scanned, for example up or down, linearly or non-linearly, in magnitude. It should be understood that a scanning electric field may be provided by ramping, for example up or down, linearly or non-linearly, the respective DC potentials and/or by pulsing the respective DC potentials.

In one example, the DC power supply is configured to apply non-scanning DC potentials to the set of electrodes to provide a non-scanning electric field in the region (i.e. the electric field is a non-scanning electric field, provided by the respective non-scanning DC potentials applied to the set of electrodes). It should be understood that the respective non-scanning DC potentials applied to the set of electrodes do not change in magnitude (i.e. a voltage level) (notwithstanding that the respective DC potentials may be pulsed to the same second DC potential, for example) and are not reversed in polarity. In this way, the electric field is non-scanning, for example static. It should be understood that a non-scanning electric field may be provided by constant respective DC potentials and/or by pulsing the respective DC potentials.

In one example, the DC power supply is configured to apply the respective DC potentials to the set of electrodes selectively, for example: synchronised with respect to introduction of the ions into the region by the ion inlet such as only when ions are introduced into the region by the ion inlet; at a predetermined time and/or for a predetermined duration such as to selectively separate particular ions using the DMS device; in response to a control signal such as received from an ion source configured to provide the ions, from a GC or an LC upstream of the ion inlet and/or from a feedback signal such as received from the analyser downstream of the DMS device. In this way, the mutually spatially separated ions correspondingly deposited on the first electrode as respective mutually spatially separated analytes are selected by applying the respective DC potentials to the set of electrodes selectively.

### Gas Source

The DMS device comprises the gas source arranged to provide the flow of gas in the region transverse, preferably orthogonal, to the electric field.

In one example, the gas source comprises a gas flow straightener configured to provide a laminar flow of the gas in the region. In this way, flow the gas in the region is relatively constant therethrough. Suitable gas flow straighteners are known.

In one example, the region does not include (i.e. excludes) obstructions and/or protrusions adversely affecting the flow of the gas.

### Ion Inlet

The DMS device comprises the ion inlet disposed to introduce ions (more generally, charged aerosol particles or ions) into the region.

In one example, the ion inlet is disposed to introduce the ions transversely, preferably orthogonally, to the flow of gas in the region. In this way, the ions are transported by the flow of gas away from the ion inlet (i.e. downstream). In one example, the ion inlet is disposed to introduce the ions transversely, preferably orthogonally, to the set of electrodes, for example the second electrode and/or the first electrode. In this way, the ions are accelerated by the electric field or a component thereof, away from the ion inlet. In one example, the ion inlet is disposed to introduce the ions aligned with, preferably parallel to, the electric field. In this way, the ions are accelerated by the electric field or a component thereof, away from the ion inlet. In one example, the ion inlet is disposed to introduce the ions transversely, preferably orthogonally, to the flow of gas in the region and to introduce the ions aligned with, preferably parallel to, the electric field. In this way, the ions are transported by the flow of gas away from the ion inlet (i.e. downstream) and accelerated by the electric field or a component thereof.

In one example, the ion inlet is provided in the second electrode, for example through the second electrode such as via an aperture provided in the second electrode. In this way, the ions are transported by the flow of gas away from the ion inlet (i.e. downstream) and accelerated by the electric field or a component thereof.

In one example, the aperture provided in the second electrode comprises and/or is a slit (i.e. a rectangular perforation through the second electrode), having a relatively narrow width in the direction of the flow of the gas and a relatively long length in the transverse direction. In this way, the ions introduced via the inlet into the region are collimated by the slit in the direction of the flow of the gas, thereby constraining a spatial origin thereof in the direction of the flow of the gas and hence increasing a resolution of the mutually spatially separated ions correspondingly deposited on the first electrode as respective mutually spatially separated analytes. In contrast, the relatively long length of the aperture enables a relatively higher flux of ions through the ion inlet. In one example, the width of the slit is in a range from 10 μm to 1,000 μm, preferably in a range from 50 μm to 750 μm, more preferably in a range from 100 μm to 500 μm. In one example, the length of the slit is in a range from 1 mm to 100 mm, preferably in a range from 5 mm to 50 mm, more preferably in a range from 10 mm to 25 mm. In one example, the thickness of the slit (i.e. thickness of the second electrode) is in a range from 10 μm to 1,000 μm, preferably in a range from 50 μm to 750 μm, more preferably in a range from 100 μm to 500 μm. In one example, edges of the slit are radiused or chamfered, for example downstream edges, to improve gas flow. Additionally and/or alternatively, in one example, the aperture provided in the second electrode comprises and/or is a series of relatively smaller perforations, such as circular perforations, disposed in a line, analogous to a slit. Other shapes of apertures may be provided.

In one example, the ion inlet does not protrude into the region. in this way, the flow of the gas in the region is not perturbed.

### Ion Guide

In one example, the apparatus comprises an ion guide configured to guide the ions towards the ion inlet. In this way, a flux of ions through the ion inlet and introduces into the region may be relatively increased, for example by focusing the ions through the ion inlet. In one example, the ion guide comprises and/or is a quadrupole, a hexapole, an octapole, a decapole or a dodecapole, preferably a quadrupole. In one example, the ion guide comprises round rods, hyperbolic rods or planar rods, for example rectangular rods or square rods. In one example, the ion guide comprises and/or is a stacked ring ion guide. In one example, the ion guide comprises an/or is an ion funnel. Other ion guides are known.

### Separation

The ions are mutually spatially separated in the flow of the gas according to their respective differential gas phase ion mobilities by the electric field. Differential mobility separation is known.

### Gas

The gas can comprise any non-conductive gaseous chemical. The gas may comprise a nominally inert gas, for example nitrogen and/or argon, or it may be a reactive gas, for example hydrogen and/or oxygen, or a mixture of both inert and reactive gases. Preferably, the gas comprises a gas with high dielectric strength such as nitrogen and/or air.

The gas flow rate and the electric potential define the resolution for a given analyte. Providing the flow condition can be kept laminar the best resolution is obtained using the maximum gas flow rate and the highest possible electric potential. The maximum gas flow rate is limited by the driver, for example a gas pump, turbulence, and/or choked flow condition. The maximum electric potential will depend on the dielectric breakdown of the gas. The gas flow rate and electric potential can be further tuned to provide the best resolution for an analyte or range of analytes of interest.

The gas flow rate (in meters per second) may be from 20 m/s, such as from 60 m/s, preferably from 100 m/s, more preferably from 140 m/s, most preferably from 180 m/s.

The gas flow rate may be up to 500 m/s, such as 400 m/s, preferably 300 m/s, more preferably, 260 m/s, most preferably 220 m/s.

The gas flow rate may be from 20 to 500 m/s, such as from 60 to 400 m/s, preferably from 100 to 300 m/s, more preferably from 140 to 260 m/s, most preferably from 180 to 220 m/s.

The electric field strength can be varied from 100 V/cm to 10 kV/cm preferably around 8 kV/cm.

The electric potential (in V/cm) may be from 100 V/cm, such as from 500 V/cm, preferably from 1000 V/cm, more preferably from 3000 V/cm, most preferably from 5000 V/cm.

The electric potential may be up to 10000 V/cm, such as up to 9500 V/cm, preferably up to 9000 V/cm, more preferably up to 8500 V/cm, most preferably up to 8250 V/cm.

The electric potential may be from 100 to 10000 V/cm, such as from 500 to 9500 V/cm, preferably from 1000 to 9000 V/cm, more preferably from 3000 to 8500 V/cm, most preferably from 5000 to 8250 V/cm.

### Deposition

The mutually spatially separated ions are correspondingly deposited on the first electrode as respective mutually spatially separated analytes. That is, the first electrode provides a substrate (more generally, a surface) for deposition of the mutually spatially separated ions, upon which the mutually spatially separated ions deposit (i.e. accumulate), generally as uncharged analytes, at corresponding locations (i.e. corresponding with the respective trajectories in the region). It should be understood that movement, for example migration and/or diffusion, of the deposited mutually spatially separated analytes on the first electrode is negligible and hence the mutually spatially separated analytes remain on the first electrode in their respective deposition locations.

### Interface

The DMS device comprises the interface to the analyser for analysis of the mutually spatially separated analytes deposited on the first electrode.

In this way, the mutually spatially separated analytes deposited on the first electrode may be, for example subsequently and/or simultaneously, analysed using the analyser via the interface. In this way, mixtures of ions may be mutually spatially separated, based on their respective differential gas phase ion mobilities, and the mutually spatially separated analytes deposited on the first electrode analysed, for example characterised, identified and/or quantified, using the analyser via the interface. In this way, analytical resolution is enhanced since the mixtures of ions are first mutually separated before analysis, enabling discrimination of analytes, for example, that would not otherwise be resolved using the analyser such as due to interferences, improving sensitivity (signal to noise ratio) and/or a limit of detection of the respective analytes of the analyser and/or eliminating the requirement to chromatographically separate the analytes before analysis using the analyser. Additionally and/or alternatively, by depositing the mutually spatially separated ions in and/or as mutually spatially separated respective lines or bands on the first electrode, the respective analytes are effectively integrated by accumulation on the first electrode, thereby increasing an amount thereof for analysis using the analyser and hence improving sensitivity and/or a limit of detection of the respective analytes.

In one example, the first electrode comprises and/or is a removable electrode and wherein the interface comprises the first electrode for off-line analysis of the mutually spatially separated analytes deposited on the first electrode. In this way, the first electrode may be removed from the apparatus, for off-line analysis of the mutually spatially separated analytes deposited on the first electrode using the analyser.

In one example, the apparatus is configurable in:
a first configuration, wherein the first electrode is disposed internally to the apparatus, whereby the mutually spatially separated ions are correspondingly depositable on the first electrode as respective mutually spatially separated analytes, for example wherein the first electrode is disposed to provide, at least in part, the region and wherein a respective DC potential is applied to the first electrode to provide the electric field in the region; and
a second configuration, wherein the first electrode is disposed externally to the apparatus, whereby the mutually spatially separated analytes deposited on the first electrode are analysable using the analyser, for example off-line;
optionally, wherein the apparatus is adapted to move from the first configuration to the second configuration (optionally, repeatedly and/or vice versa) by removing the first electrode from the apparatus.

In one example, the DMS device, for example the DC power supply, comprises a set of electrical terminals (also known as contacts), including a first electrical terminal and a second electrical terminal, wherein respective electrodes of the set thereof are electrically coupled or electrically coupleable (i.e. may be electrically coupled and uncoupled, for example repeatedly) to the respective electrical terminals of the set thereof. In this way, the first electrode, such as a removable electrode, may be removed and electrically uncoupled from the first electrical terminal. For example, the first electrode may be disposed on the first electrical terminal.

### First Electrode

The first electrode may be made of any metal or any other conductive material that would not by virtue of its properties interfere negatively with the flow within the DMA cell or the Raman or other spectroscopic technique (such as fluorescence spectroscopy). The first electrode may be made of a semiconductor material such as silicon, germanium and/or semiconductive polymer.

Typically, the first electrode is conductive and flat. Surface features of the first electrode may be below 75 μm, preferably below 50 μm, most preferably below 25 μm. For example, the first electrode material may be selected from the group comprising stainless steel, conductive glass, such as ITO coated or nanowire coated glass, FR4 (or other glass-reinforced epoxy laminate material), or a ceramic material with a conductive layer added.

The first electrode may be modified to exhibit a SERS enhancement effect. This may be achieved by any method known in the art. In one example, the SERS enhancement effect may be achieved by the addition of a fine coating of nanostructures (for example, noble metal nanoparticles). In one example, the SERS enhancement effect may be achieved by creating nanoscopic features such as “plasmonic hot spots” on the first electrode exhibiting said SERS effect. In one example, the first electrode may be left bear to accommodate tip enhanced Raman spectrometry (TERS).

The first electrode may be modified to be operable for other spectroscopy techniques, for example fluorescence spectroscopy.

The first electrode may be a single first electrode or may comprise a set of first electrodes. A set of first electrodes may advantageously allow deposition monitoring by specialized electronics. For example, a set of first electrodes may be coupled with an integrator to provide real time information about the rate of deposition.

In one example the first electrode may be composed of an optically transparent material. A first electrode composed of an optically transparent material may be used as a waveguide or a window and/or as a light amplification medium to facilitate optical read out and/or to utilise an evanescent field.

The first electrode surface may be modified. In one example, the first electrode surface may be coated uniformly with nanoparticles using any suitable deposition technique, method or combination of techniques or methods that provides a highly uniform coating, for example electrospray deposition, electrostatic field-controlled deposition and/or a controlled evaporation process.

The first electrode may be prepared by any suitable lithography, micro machining, nano machining and/or modifying process. In one example, a first electrode prepared by any suitable lithography, micro machining, nano machining and/or modifying process will advantageously exhibit a SERS enhancement effect.

In one example, the interface comprises a port (i.e. a window, optionally closeable) for on-line analysis of the mutually spatially separated analytes deposited on the first electrode via the port. In this way, the mutually spatially separated analytes deposited on the first electrode may be analysed in situ using the analyser via the port. For example, SERS of the mutually spatially separated analytes deposited on the first electrode may be performed in situ via the port. Other analyses using other analysers (optionally, a plurality thereof) maybe similarly performed mutatis mutandis.

### Ion Source

In one example, the apparatus comprises an ion source configured to provide the ions, for example by: electron ionisation and/or electron capture ionisation; chemical ionisation, such as charge exchange ionisation, chemi-ionisation, associative ionisation, Penning ionisation and/or ion attachment; gas discharge ionisation such as inductively-coupled plasma, microwave-induced plasma, electron cyclotron resonance ionisation, glow discharge ionisation, flowing afterglow ionisation and/or spark ionisation; photoionisation such as multiphoton ionisation and/or atmospheric pressure photoionisation; desorption ionisation such as field desorption, particle bombardment such as fast atom bombardment, secondary ionisation and/or plasma desorption ionisation, radioactive ionisation which leads to the decay of charged species, laser desorption ionisation such as surface assisted laser desorption ionisation, surface enhanced laser desorption ionisation and/or aerosol ionisation; spray ionisation such as matrix-assisted ionisation, atmospheric pressure chemical ionisation, thermospray ionisation, electrospray ionisation, probe electrospray ionisation, contactless atmospheric pressure ionisation, sonic spray ionisation and/or ultrasonication-assisted spray ionisation; thermal ionisation; ambient ionisation such as desorption electrospray ionisation and/or direct analysis in real time ionisation, bipolar diffusion charging of aerosol. Other ion sources are known.

### Grids

In one example, the DMS device comprises a set of grids (for example, a first set of grids) including a first grid (i.e. a mesh), disposed in the region, optionally transverse, preferably orthogonal, to the electric field, for example aligned with, preferably parallel to, the set of electrodes, for example the first electrode and/or the second electrode. In this way, the electric field may be controlled, for example by applying respective DC potentials to the set of grids using the DC power supply and/or grounding one or more of the grids included in the set of grids.

In one example, the first grid is disposed in the region, transverse, preferably orthogonal, to the electric field, for example aligned with, preferably parallel to, the set of electrodes, for example the first electrode and relatively proximal to the first electrode, wherein a respective DC potential is applied to the first grid to provide, at least in part, the electric field in the region, whereby the mutually spatially separated ions are correspondingly deposited on the first electrode through the first grid as respective mutually spatially separated analytes, and optionally, wherein the respective DC potential applied to the first electrode is relatively lower in magnitude than the respective DC potential that is applied to the first grid, for example 0 V. In this way, the electric field for separating the ions according to their respective differential gas phase ion mobilities is additionally and/or alternatively provided by the first grid (i.e. the first electrode) while the mutually spatially separated ions are correspondingly deposited as respective mutually spatially separated analytes on a substrate, which may be at a different or 0 V DC potential. In this way, the substrate may be provided by an electrical conductor or an electrical insulator, for example. It should be understood that the first grid may be otherwise as described with respect to the first electrode mutatis mutandis.

Hence, additionally and/or alternatively, the first aspect provides an apparatus including:
a differential mobility separation, DMS, device comprising:
a set of mutually spaced apart electrodes, including a first electrode (for example, a first grid as described previously) and a second electrode having a region therebetween; a DC power supply configured to apply respective DC potentials to the set of electrodes to provide an electric field in the region; a gas source arranged to provide a flow of gas in the region transverse, preferably orthogonal, to the electric field; and an ion inlet disposed to introduce ions into the region, wherein the ions are mutually spatially separated in the flow of the gas according to their respective differential gas phase ion mobilities by the electric field and wherein the mutually spatially separated ions are correspondingly deposited on a substrate as respective mutually spatially separated analytes; and
wherein the DMS device comprises an interface to an analyser for analysis of the mutually spatially separated analytes deposited on the substrate.

In one example, the DMS device comprises a set of grids (for example, a second set of grids) including a first grid (i.e. a mesh), disposed in the region, optionally transverse, preferably orthogonal, to the flow of the gas. In this way, an extent of the electric field in the direction of the flow of the gas may be controlled, for example by applying respective DC potentials to the set of grids using the DC power supply and/or grounding one or more of the grids included in the set of grids. In this way, a target deposition area on the first electrode may be defined, for example between two adjacent grids, respectively upstream and downstream of the ion inlet, or by one grid downstream of the ion inlet.

### Analyser

In one example, the apparatus comprises the analyser. It should be understood that the apparatus optionally comprises the analyser, which is not essential to the apparatus. Rather, the DMS device comprises the interface to an analyser for analysis of the mutually spatially separated analytes deposited on the first electrode.

In one example, the analyser is selected from a group consisting of: Raman spectroscopy such as surface-enhanced Raman spectroscopy, surface-enhanced Raman scattering (SERS) spectroscopy, tip enhanced Raman spectroscopy (TERS) and total internal reflection (TIR) Raman spectroscopy; mass spectrometry (MS) such as matrix-assisted laser desorption/ionization (MALDI) MS, ambient ionization MS including desorption electrospray ionization (DESI) MS, direct analysis in real time (DART) MS and liquid extraction surface analysis (LESA) MS; attenuated total reflection (ATR) and reflection-absorption (RAIR) infrared spectroscopy; X-ray photoelectron spectroscopy (XPS); Auger electron spectroscopy (AES); secondary ion mass spectrometry (SIMS); fluorescence spectroscopy; Fourier transform infrared (FTIR) spectroscopy such as attenuated total reflection (ATR) FTIR spectroscopy; atomic emission spectroscopy (AES); and atomic absorption spectroscopy (AAS). Other analysers are known.

### Method

The second aspect provides a method of analysing a sample comprising analytes, the method comprising:
ionising the analytes to provide ions therefrom;
introducing the ions into a region having an electric field and a mutually transverse flow of a gas;
mutually spatially separating the ions in the flow of the gas according to their respective differential gas phase ion mobilities by the electric field;
correspondingly depositing the mutually spatially separated ions on an electrode as respective mutually spatially separated analytes; and
analysing the mutually spatially separated analytes deposited on the electrode.

The method may include any of the steps as described with respect to the first aspect, mutatis mutandis.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A is a top view CAD drawing of apparatus according to an exemplary embodiment; FIG. 1B is a frontside view CAD drawing of the apparatus; FIG. 1C is a left view CAD drawing of the apparatus; and FIG. 1D is a perspective view, from above front left, CAD drawing of the apparatus;

FIG. 2 schematically depicts the apparatus of FIG. 1, in use;

FIG. 3 schematically depicts a method according to an exemplary embodiment;

FIG. 4 schematically depicts a conventional method;

FIG. 5 schematically depicts a method according to an exemplary embodiment;

FIG. 6 shows results of the method of FIG. 5;

FIG. 7 shows results of the method of FIG. 5;

FIG. 8 schematically depicts a method according to an exemplary embodiment;

FIG. 9 schematically depicts the method of FIG. 8, in more detail;

FIG. 10 schematically depicts the method of FIG. 8, in more detail; and

FIG. 11 schematically depicts a method according to an exemplary embodiment.

### DETAILED DESCRIPTION OF THE DRAWINGS

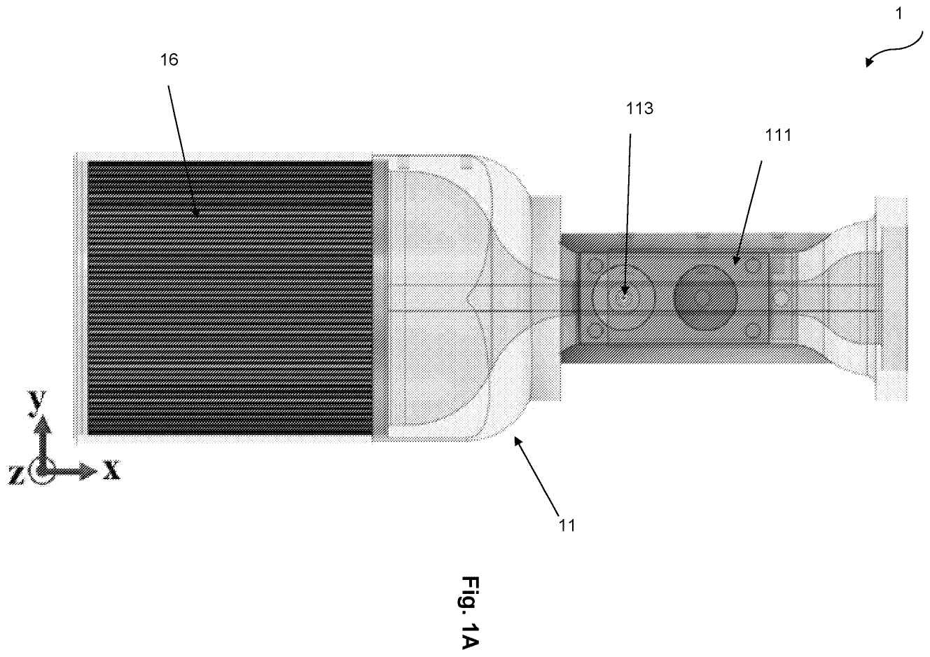

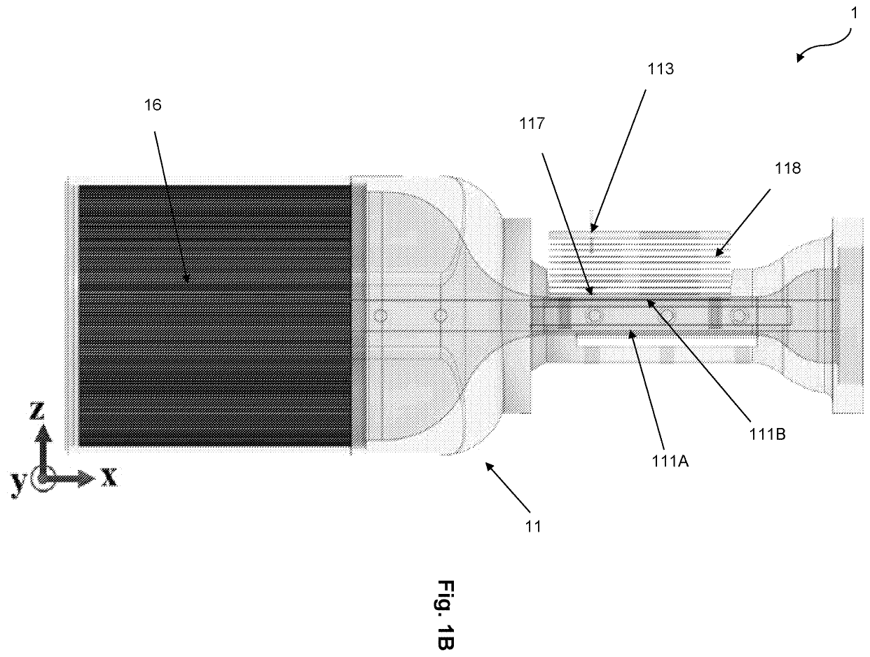

FIG. 1A is a top view CAD drawing of apparatus according to an exemplary embodiment; FIG. 1B is a frontside view CAD drawing of the apparatus; FIG. 1C is a left view CAD drawing of the apparatus; and FIG. 1D is a perspective view, from above front left, CAD drawing of the apparatus.

The first aspect provides an apparatus 1 including:
a differential mobility separation, DMS, device 11 comprising:
a set of mutually spaced apart electrodes 111, including a first electrode 111A and a second electrode 111B having a region R therebetween; a DC power supply 112 (not shown) configured to apply respective DC potentials to the set of electrodes 111 to provide an electric field E in the region R; a gas G source arranged to provide a flow F of gas G in the region R transverse, preferably orthogonal, to the electric field E; and an ion inlet 113 disposed to introduce ions I into the region R, wherein the ions I are mutually spatially separated in the flow F of the gas G according to their respective differential gas phase ion mobilities by the electric field E and wherein the mutually spatially separated ions S are correspondingly deposited on the first electrode 111A as respective mutually spatially separated analytes A; and
wherein the DMS device 11 comprises an interface 114 to an analyser 115 for analysis of the mutually spatially separated analytes A deposited on the first electrode 111A.

The apparatus 1 comprises the differential mobility separation, DMS, device 11 (also known as differential mobility analyser, DMA).

The DMS device 11 comprises the set of mutually spaced apart electrodes 111, including the first electrode 111A and the second electrode 111B having the region R (i.e. a lumen, a gap) therebetween. It should be understood that the electrodes 111 of the set thereof are electrically conductive and/or comprise electrically conductive surfaces (i.e. sufficiently electrically conductive to provide the electric field E in the region R), for example mutually opposed electrically conductive surfaces having the region R therebetween. Suitable electrical conductors are known.

In this example, the set of mutually spaced apart electrodes 111 consists of parallel plate electrodes 111, wherein the first electrode 111A and the second electrode 111B are mutually parallel. In this way, the electric field E in the region R is uniform, for example axially and/or transversally with respect to the set of mutually spaced apart electrodes 111. In this example, the first electrode 111A comprises and/or is a planar electrode. In this example, the second electrode 111B comprises and/or is a planar electrode.

In this example, the set of mutually spaced apart electrodes 111 comprises and/or consists of parallel plate, segmented electrodes 111, for example, wherein the first electrode 111A and the second electrode 111B are mutually parallel segmented electrodes 111.

The DMS device 11 comprises the DC power supply 112 configured to apply the respective DC potentials to the set of electrodes 111 to provide the electric field E in the region R. Suitable DC power supplies are known.

In this example, the DC power supply 112 comprises and/or consists of a DC-only power supply. In this way, the respective DC potentials to the set of electrodes 111 are DC-only potentials (c.f. AC potentials applied by an AC power supply).

In this example, the DMS device 11 excludes (i.e. does not include) an AC power supply configured to apply respective AC potentials to the set of electrodes 111.

In this example, the DC power supply 112 is configured to apply respective constant (i.e. non-time varying or non-pulsed) DC potentials to the set of electrodes 111 to provide a static electric field E in the region R (i.e. the electric field E is a static electric field E, provided by the respective constant DC potentials applied to the set of electrodes 111).

In this example, the DC power supply 112 is configured to apply non-scanning DC potentials to the set of electrodes 111 to provide a non-scanning electric field E in the region R (i.e. the electric field E is a non-scanning electric field E, provided by the respective non-scanning DC potentials applied to the set of electrodes 111). It should be understood that the respective non-scanning DC potentials applied to the set of electrodes 111 do not change in magnitude (i.e. a voltage level) (notwithstanding that the respective DC potentials may be pulsed to the same second DC potential, for example) and are not reversed in polarity

In this example, the DC power supply 112 is configured to apply the respective DC potentials to the set of electrodes 111 selectively, for example: synchronised with respect to introduction of the ions I into the region R by the ion inlet 113 such as only when ions are introduced into the region R by the ion inlet 113; at a predetermined time and/or for a predetermined duration such as to selectively separate particular ions using the DMS device 11; in response to a control signal such as received from an ion source configured to provide the ions I, from a GC or an LC upstream of the ion inlet 113 and/or from a feedback signal such as received from the analyser 115 downstream of the DMS device 11.

The DMS device 11 comprises the gas G source arranged to provide the flow F of gas G in the region R transverse, preferably orthogonal, to the electric field E.

In this example, the gas G source comprises a gas G flow F straightener 16 configured to provide a laminar flow F of the gas G in the region R. In this way, flow F the gas G in the region R is relatively constant therethrough. Suitable gas G flow F straighteners are known.

In this example, the region R does not include (i.e. excludes) obstructions and/or protrusions adversely affecting the flow F of the gas G.

The DMS device 11 comprises the ion inlet 113 disposed to introduce ions (more generally, charged aerosol particles or ions) into the region R.

In this example, the ion inlet 113 is disposed to introduce the ions I orthogonally to the flow F of gas G in the region R. In this example, the ion inlet 113 is disposed to introduce the ions I orthogonally to the set of electrodes 111, for example the second electrode 111B and/or the first electrode 111A. In this example, the ion inlet 113 is disposed to introduce the ions I parallel to the electric field E. In this example, the ion inlet 113 is disposed to introduce the ions I orthogonally to the flow F of gas G in the region R and to introduce the ions I aligned with, preferably parallel to, the electric field E.

In this example, the ion inlet 113 is provided in the second electrode 111B, through the second electrode 111B such as via an aperture provided in the second electrode 111B.

In this example, the aperture provided in the second electrode 111B comprises and/or is a slit 117 (i.e. a rectangular perforation through the second electrode 111B), having a relatively narrow width in the direction of the flow F of the gas G and a relatively long length in the transverse direction. In this example, the width of the slit 117 is in a range from 10 μm to 1,000 μm, preferably in a range from 50 μm to 750 μm, more preferably in a range from 100 μm to 500 μm. In this example, the length of the slit 117 is in a range from 1 mm to 100 mm, preferably in a range from 5 mm to 50 mm, more preferably in a range from 10 mm to 25 mm. In this example, the thickness of the slit 117 (i.e. thickness of the second electrode 111B) is in a range from 10 μm to 1,000 μm, preferably in a range from 50 μm to 750 μm, more preferably in a range from 100 μm to 500 μm. In this example, edges of the slit 117 are radiused or chamfered, for example downstream edges, to improve gas G flow F.

In this example, the ion inlet 113 does not protrude into the region R. In this way, the flow F of the gas G in the region R is not perturbed.

In this example, the apparatus 1 comprises an ion guide 118 configured to guide the ions I towards the ion inlet 113. In this way, a flux of ions through the ion inlet 113 and introduces into the region R may be relatively increased, for example by focusing the ions I through the ion inlet 113. In this example, the ion guide 118 comprises and/or is a stacked ring ion guide.

The ions I are mutually spatially separated in the flow F of the gas G according to their respective differential gas phase ion mobilities by the electric field E. Differential mobility separation is known.

In this example gas G comprises air. The gas G Flow rate F is tuneable and ranges from 50 m/s to 200 m/s. The electric field strength E is tuneable and ranges from 2 kV/cm to 10 kV/cm.

The mutually spatially separated ions S are correspondingly deposited on the first electrode 111A as respective mutually spatially separated analytes A. That is, the first electrode 111A provides a substrate (more generally, a surface) for deposition of the mutually spatially separated ions S, upon which the mutually spatially separated ions S deposit (i.e. accumulate), generally as uncharged analytes, at corresponding locations (i.e. corresponding with the respective trajectories in the region R).

The DMS device 11 comprises the interface 114 (not shown) to the analyser 115 (not shown) for analysis of the mutually spatially separated analytes A deposited on the first electrode 111A.

In this example, the first electrode 111A comprises and/or is a removable electrode and wherein the interface 114 comprises the first electrode 111A for off-line analysis of the mutually spatially separated analytes A deposited on the first electrode 111A. In this way, the first electrode 111A may be removed from the apparatus 1, for off-line analysis of the mutually spatially separated analytes A deposited on the first electrode 111A using the analyser 115.

In this example, the apparatus 1 is configurable in:
a first configuration, wherein the first electrode 111A is disposed internally to the apparatus 1, whereby the mutually spatially separated ions S are correspondingly depositable on the first electrode 111A as respective mutually spatially separated analytes A, for example wherein the first electrode 111A is disposed to provide, at least in part, the region R and wherein a respective DC potential is applied to the first electrode 111A to provide the electric field E in the region R; and
a second configuration, wherein the first electrode 111A is disposed externally to the apparatus 1, whereby the mutually spatially separated analytes A deposited on the first electrode 111A are analysable using the analyser 115, for example off-line;
optionally, wherein the apparatus 1 is adapted to move from the first configuration to the second configuration (optionally, repeatedly and/or vice versa) by removing the first electrode 111A from the apparatus 1.

In this example, the DMS device 11, for example the DC power supply 112, comprises a set of electrical terminals (also known as contacts), including a first electrical terminal and a second electrical terminal, wherein respective electrodes 111 of the set thereof are electrically coupled or electrically coupleable (i.e. may be electrically coupled and uncoupled, for example repeatedly) to the respective electrical terminals of the set thereof. In this way, the first electrode 111A, such as a removable electrode, may be removed and electrically uncoupled from the first electrical terminal. For example, the first electrode 111A may be disposed on the first electrical terminal.

Alternatively and/or additionally, in one example, the first electrode 111A is modified to exhibit a SERS enhancement effect. In one example, the SERS enhancement effect is achieved by the addition of a fine coating of nanostructures. In one example, the SERS enhancement effect is achieved by creating nanoscopic features such as “plasmonic hot spots” on the first electrode exhibiting said SERS effect. In one example, the first electrode may be left bear to accommodate tip enhanced Raman spectrometry (TERS).

In this example, the first electrode is made of any metal or any other conductive material that would not by virtue of its properties interfere negatively with the flow within the DMA cell or the Raman or other spectroscopic technique (such as fluorescence spectroscopy). Alternatively, in one example, the first electrode is made of a semiconductor material such as silicon, germanium and/or semiconductive polymer.

In this example, the first electrode is conductive and flat. Surface features of the first electrode may be below 75 μm, preferably below 50 μm, most preferably below 25 μm. Alternatively and/or additionally, in one example the first electrode material may be selected from the group comprising stainless steel, conductive glass, such as ITO coated or nanowire coated glass, FR4 (or other glass-reinforced epoxy laminate material), or a ceramic material with a conductive layer added.

In this example, the apparatus 1 comprises an ion source 119 (not shown) configured to provide the ions I, for example by: electron ionisation and/or electron capture ionisation; chemical ionisation, such as charge exchange ionisation, chemical-ionisation, associative ionisation, Penning ionisation and/or ion attachment; gas G discharge ionisation such as inductively-coupled plasma, microwave-induced plasma, electron cyclotron resonance ionisation, glow discharge ionisation, flowing afterglow ionisation and/or spark ionisation; photoionisation such as multiphoton ionisation and/or atmospheric pressure photoionisation; desorption ionisation such as field desorption, particle bombardment such as fast atom bombardment, secondary ionisation and/or plasma desorption ionisation, laser desorption ionisation such as surface assisted laser desorption ionisation, surface enhanced laser desorption ionisation and/or aerosol ionisation; spray ionisation such as matrix-assisted ionisation, atmospheric pressure chemical ionisation, thermospray ionisation, electrospray ionisation, probe electrospray ionisation, contactless atmospheric pressure ionisation, sonic spray ionisation and/or ultrasonication-assisted spray ionisation; thermal ionisation; ambient ionisation such as desorption electrospray ionisation and/or direct analysis in real time ionisation, bipolar diffusion charging of aerosol. Other ion sources are known.

In this example, the apparatus 1 comprises the analyser 115 It should be understood that the apparatus 1 optionally comprises the analyser 115, which is not essential to the apparatus 1. Rather, the DMS device 11 comprises the interface 114 to an analyser 115 for analysis of the mutually spatially separated analytes A deposited on the first electrode 111A.

In this example, the analyser 115 is surface-enhanced Raman scattering (SERS) spectroscopy.

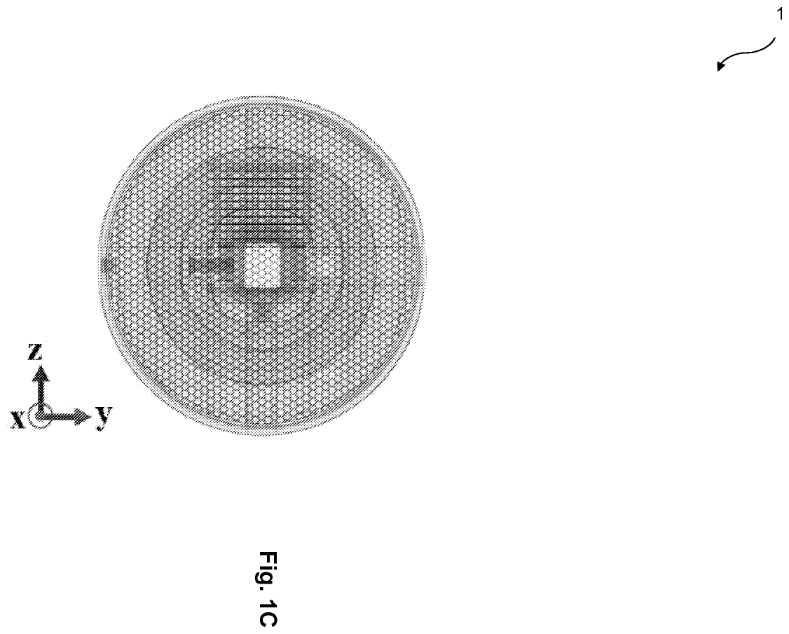

FIG. 2 schematically depicts the apparatus of FIG. 1, in use.

In this example, the gas G source comprises a gas G flow F straightener 16 configured to provide a laminar flow F of the gas G in the region R. In this way, flow F the gas G in the region R is relatively constant therethrough.

In this example, ions (more generally, charged aerosol particles or ions) of a polydisperse sample 201 are introduced into the region R through the ion inlet 113. In this example, the ion inlet 113 is disposed to introduce the ions 201 orthogonally to the flow F of gas G in the region R and to introduce the ions 201 aligned with, preferably parallel to, the electric field E.

In this example, the ion inlet 113 is provided in the second electrode 111B, through the second electrode 111B such as via an aperture provided in the second electrode 111B.

In this example, the ions 201 are mutually spatially separated in the flow F of the gas G according to their respective differential gas phase ion mobilities by the electric field E and deposited onto the first electrode 111A in regions of analytes (211A, 211B, 211C). In this example, regions of analytes 211 are distinct. Alternatively, in one example, one or more regions of analytes 211 may partially overlap if one or more analytes have similar gas phase ion mobilities in a given electric field and/or wholly overlap if one or more analytes have the same gas phase ion mobilities in a given electric field.

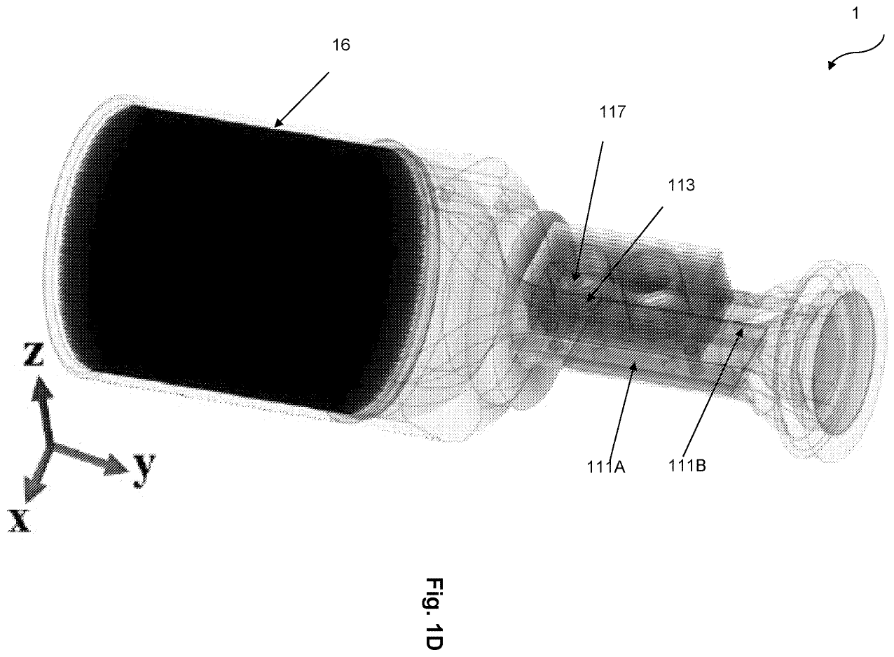

FIG. 3 schematically depicts a method according to an exemplary embodiment.

In this example, a method is provided for analysing a sample comprising analytes. Firstly, a polydisperse sample is provided 31. In this example, the polydisperse sample 312 is produced by mixing a plurality of known compounds (311A, 311B, 311C). Alternatively, in one example, the sample is provided as a mixture of unknown compounds, for example, as a crude mixture from a chemical reaction.

Secondly, in this example, the polydisperse sample undergoes DMS 32. In this example, the sample 312 is ionised in the apparatus by the ion source to provide ions I therefrom. The ions I are then introduced into a region R having an electric field E and a mutually transverse flow F of a gas G. The ions I in the flow of the gas are mutually spatially separated according to their respective differential gas phase ion mobilities by the electric field. The correspondingly mutually spatially separated ions S are deposited on a first electrode as respective mutually spatially separated analytes A.

Thirdly, the mutually spatially separated analytes A are analysed 33. In this example, the DMS device comprises the interface to the analyser for analysis of the mutually spatially separated analytes A deposited on the first electrode 111A.

In this example, the first electrode 111A comprises an area where the surface of the electrode has been modified 331 for surface-enhanced Raman scattering (SERS).

In this example, the mutually spatially separated analytes A deposited on the modified electrode 331 are then analysed in at least one analyser. In this example, the analysis is surface-enhanced Raman scattering (SERS). Additionally and/or alternatively the at least one analyser may enable: Raman spectroscopy such as surface-enhanced Raman spectroscopy, tip enhanced Raman spectroscopy (TERS) and total internal reflection (TIR) Raman spectroscopy; mass spectrometry (MS) such as matrix-assisted laser desorption/ionization (MALDI) MS, ambient ionization MS including desorption electrospray ionization (DESI) MS, direct analysis in real time (DART) MS and liquid extraction surface analysis (LESA) MS; attenuated total reflection (ATR) and reflection-absorption (RAIR) infrared spectroscopy; X-ray photoelectron spectroscopy (XPS); Auger electron spectroscopy (AES); secondary ion mass spectrometry (SIMS); fluorescence spectroscopy; Fourier transform infrared (FTIR) spectroscopy such as attenuated total reflection (ATR) FTIR spectroscopy; atomic emission spectroscopy (AES); and atomic absorption spectroscopy (AAS). Other analysers are known.

Additionally and/or alternatively, in one example, the apparatus comprises the analyser. It should be understood that the apparatus optionally comprises the analyser, which is not essential to the apparatus. Rather, the DMS device comprises the interface to an analyser for analysis of the mutually spatially separated analytes 331 deposited on the first electrode 111A.

Fourthly, the analysis may be studied 34. In this example, the analyser provides a Raman map 341. It should be understood that herein the term “Raman map” means a 2D representation of Raman signal intensity as a function of X position of an electrode surface having performed thereon the method according to the present invention. The Raman signal intensity may be the intensity at a given specified wavenumber and/or an integral of intensity over a specified range or set of ranges. The specification of wavenumber and/or range may be chosen by the user and/or programmatically. Regions of high Raman intensity represent regions of mutually spatially separated analytes A.

In this example, a 1D Raman spectrum 342 may be extracted for any given X position of the Raman map. Additionally and/or alternatively, a Raman spectrum integrating over a specified range of wavenumbers may be provided. Methods of analysing individual and sets of 1D Raman spectra are well-known.

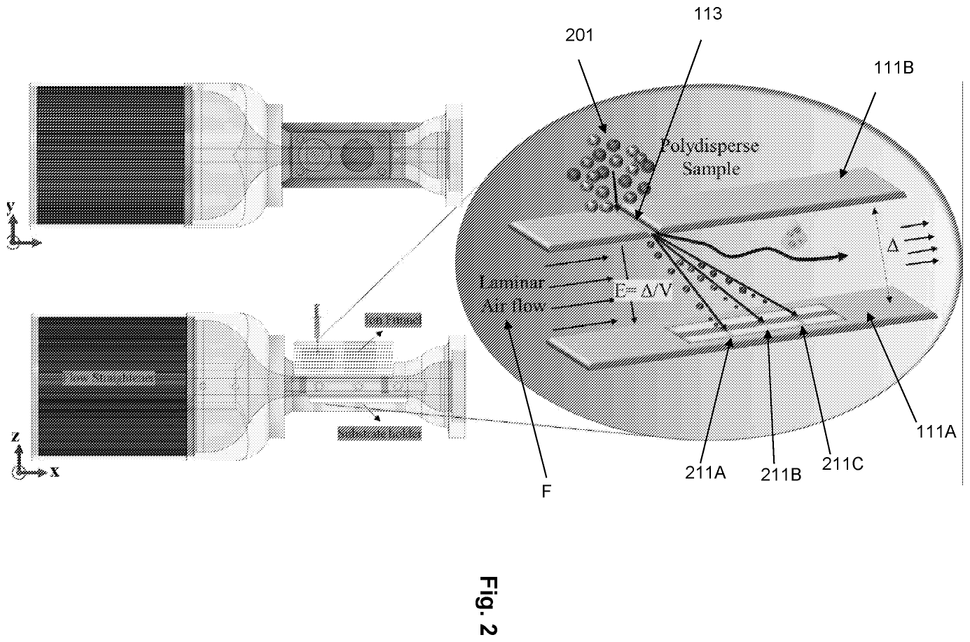

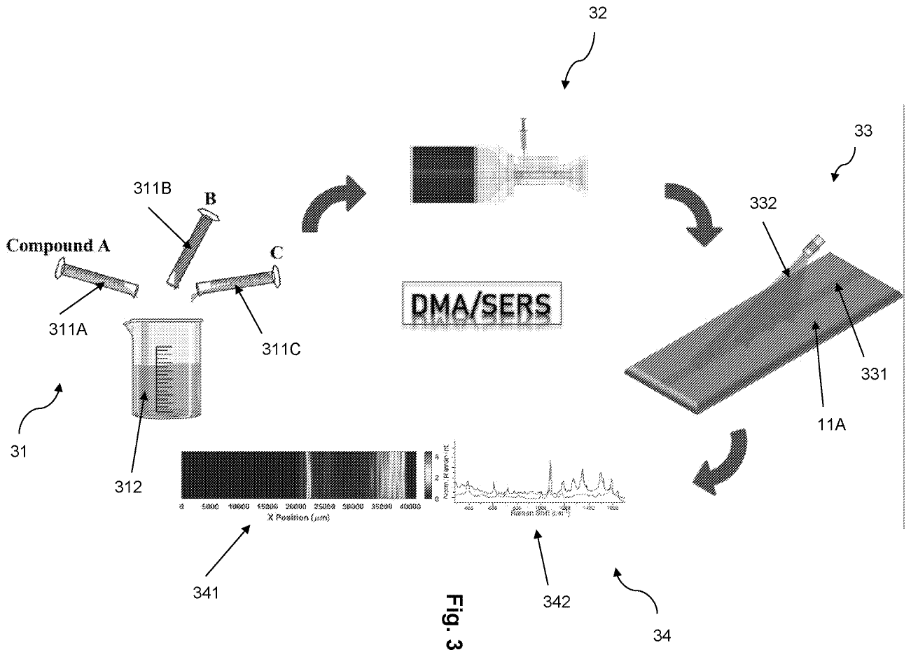

FIG. 4 schematically depicts a conventional method.

In this example, a polydisperse sample 41 comprises three compounds 411A, 411B, 411C. In this example, 411A is rhodamine B, 411B is 4-aminothiophenol, and 411C is 4-aminophenol. The Raman spectrum 42 of the polydisperse sample 41 is highly complex, comprising many spectral features.

Advantageously, the present invention enables each mutually spatially separated analyte A to be analysed individually. In this way, a Raman spectrum (RS) can be obtained for each analyte. When the results of each Raman spectrum RS are combined, a combination Raman spectrum 43 can be generated where the spectral features are separated into defined regions (431, 432, 433) that correspond to the respective mutually spatially separated analytes A. In this example, regions 431A, 431B, and 431C correspond to spectral features of a first analyte; regions 432A and 432B correspond to spectral features of a second analyte; and region 433A corresponds to spectral features of a third analyte.

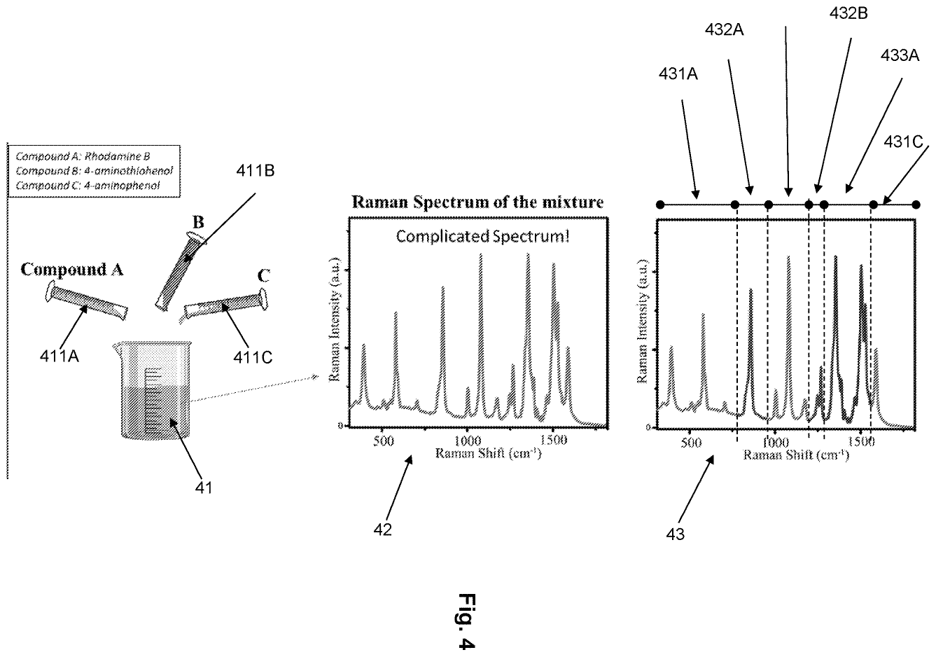

FIG. 5 schematically depicts a method according to an exemplary embodiment.

In this example, Raman map 51A shows the intensity of the Raman signal at 1355.75 cm⁻¹ as a function of X position for a pure sample of rhodamine B (411A).

In this example, Raman map 51B shows the intensity of the Raman signal at 1079.00 cm⁻¹ as a function of X position for a pure sample of 4-aminothiophenol (411B).

In this example, Raman map 51C shows the intensity of the Raman signal at 679.55 cm⁻¹ as a function of X position for a pure sample of 4-aminophenol (411C).

In this example, Raman map 52 shows the result of performing the method of the present invention on polydisperse sample comprising rhodamine B (411A), 4-aminothiophenol (411B), and 4-aminophenol (411C). Raman map 52 shows three regions of high intensity 521A, 521B, and 521C representing three regions of mutually spatially separated analytes.

In this example, the 1D Raman spectra 522 may be analysed for any value of X position. For example, the 1D spectra 522 may be extracted from X positions corresponding to the highest intensity part of regions 521A, 521B, 521C. In this way, the spectral features for each mutually spatially separated analyte may be analysed.

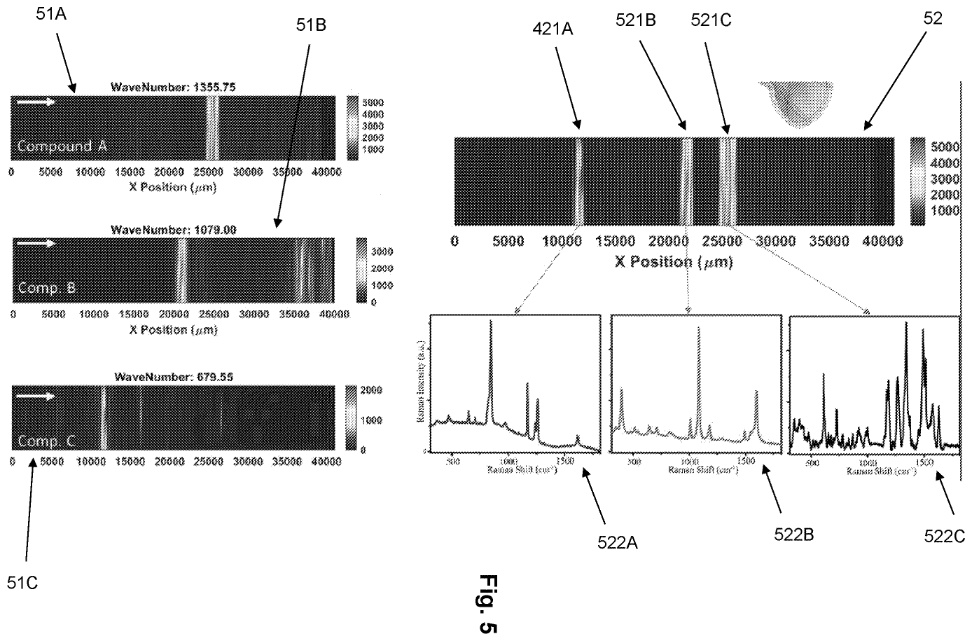

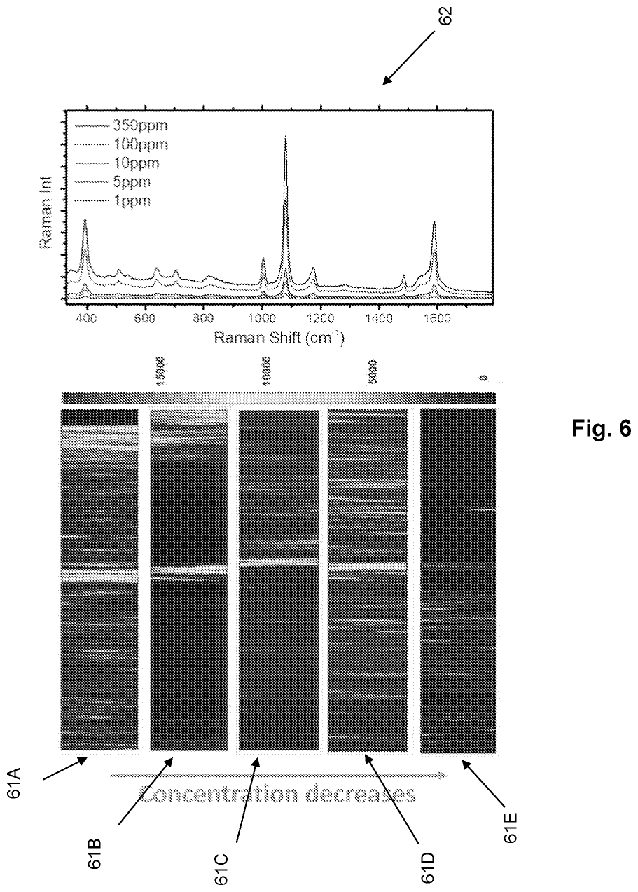

FIG. 6 shows results of the method of FIG. 5.

In this example, five Raman maps are shown for 4-aminothiophenol (411B) at five concentrations (in parts per million): 350 ppm (61A), 100 ppm (61B), 10 ppm (61C), 5 ppm (61D), and 1 ppm (61E). The 1D Raman spectrum corresponding to the most intense region of mutually spatially separated analyte are shown in graph 62.

FIG. 7 shows results of the method of FIG. 5.

In this example, the present invention combines the use of DMS and MS to identify dimers in the mutually spatially separated analytes A. Raman map 71 corresponds to 4-aminothiophenol (411B) and displays the intensity of Raman signal at 1079 cm⁻¹ as a function of X position of electrode surface. The 1D representation of Raman map 71 is shown in graph 72, which can be divided into three regions of interest 721, 722, 723, corresponding to three mutually spatially separated analytes A.

In this example, mass spectroscopy was performed on the mutually spatially separated analytes A and the results are shown in graph 73. Peaks corresponding to 4-aminothiophenol (731) and the dimer 4,4′-[(E)-1,2-Diazenediyl]dibenzenethiol (732) are clearly visible.

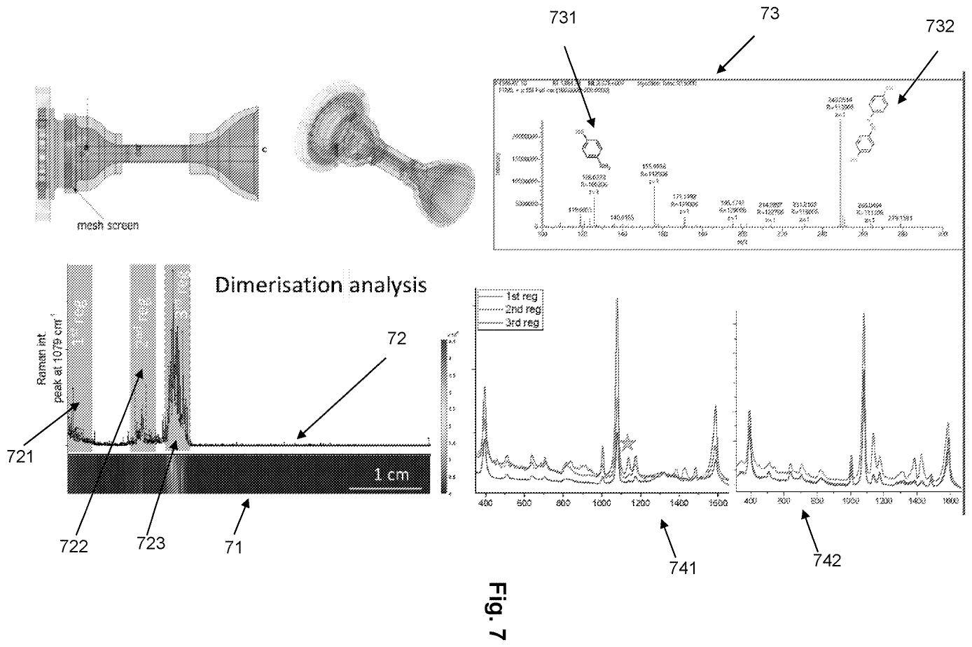

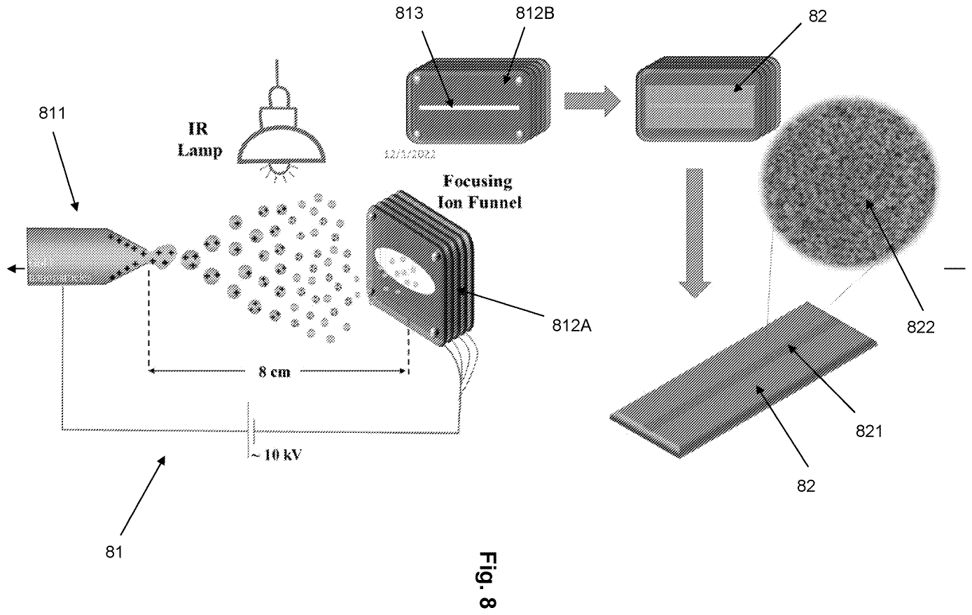

FIG. 8 schematically depicts a method according to an exemplary embodiment.

In this example, gold nanoparticles 811 are deposited on an electrode 82 via electrospray deposition 81. The gas phase gold nanoparticles are passed through a focussing ion funnel 812 which comprises a series of charged plates comprising a slit for gold nanoparticles to pass through. In this example, the focusing ion funnel comprises a rectangular slit (821B). Alternatively, the focussing ion funnel can comprise a slit of any predetermined shape, for example, a focusing ion funnel comprising an oval slit (821A).

In this example, the gold nanoparticles pass through the slit 813 and are deposited on an electrode 82. The electrode may be stationary or may be moved in an automated fashion behind the focussing ion funnel in order to deposit the gold nanoparticles over larger regions of the electrode surface.

In this example, the resulting electrode 82 has a region 821 where the surface is modified by the gold nanoparticles 822. In this example, the modified electrode is suitable for surface enhanced Raman spectroscopy (SERS). The person skilled in the art will appreciate that other surface modifications are possible in order to enable other analytical methods to be carried out on the deposited analytes.

The skilled person will also recognise that the electrode surface may be modified any number of times to provide a multi-functional electrode surface. Advantageously this may allow for multiple analytical techniques to be performed on the same electrode following DMS.

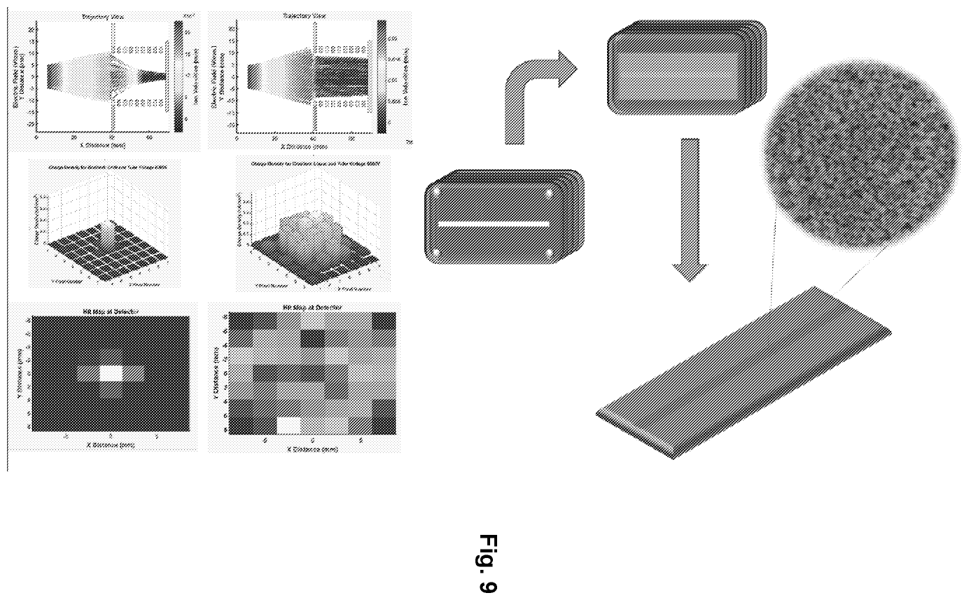

FIG. 9 schematically depicts the method of FIG. 8, in more detail.

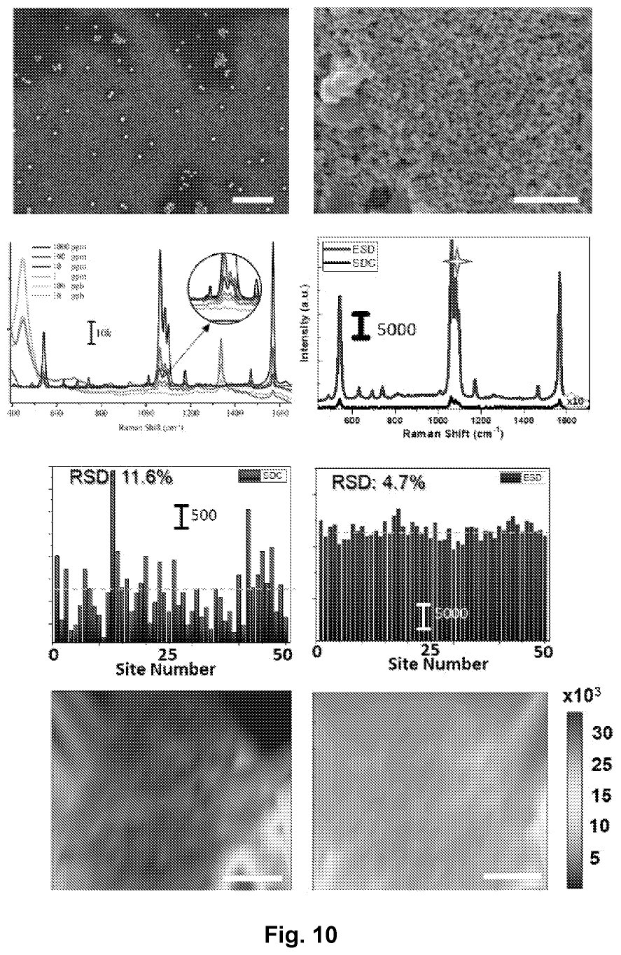

FIG. 10 schematically depicts the method of FIG. 8, in more detail.

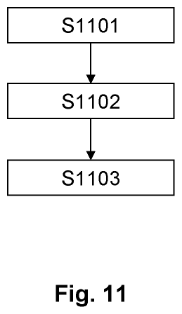

FIG. 11 schematically depicts a method according to an exemplary embodiment.

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus including:
a differential mobility separation, DMS, device comprising:
a set of mutually spaced apart electrodes, including a first electrode and a second electrode having a region therebetween;
a DC power supply configured to apply respective DC potentials to the set of electrodes to provide an electric field in the region;
a gas source arranged to provide a flow of gas in the region transverse, preferably orthogonal, to the electric field; and
an ion inlet disposed to introduce ions into the region,
wherein the ions are mutually spatially separated in the flow of the gas according to their respective differential gas phase ion mobilities by the electric field and wherein the mutually spatially separated ions are correspondingly deposited on the first electrode as respective mutually spatially separated analytes; and
wherein the DMS device comprises an interface to an analyser for analysis of the mutually spatially separated analytes deposited on the first electrode.

2. The apparatus according to claim 1, wherein the first electrode comprises and/or is a removable electrode and wherein the interface comprises the first electrode for off-line analysis of the mutually spatially separated analytes deposited on the first electrode.

3. The apparatus according to claim 1, wherein the interface comprises a port for on-line (in-situ) analysis of the mutually spatially separated analytes deposited on the first electrode via the port.

4. The apparatus according to claim 1, wherein the gas source comprises a gas flow straightener configured to provide a laminar flow of the gas in the region.

5. The apparatus according to claim 1, wherein the ion inlet is provided in the second electrode.

6. The apparatus according to claim 1, further comprising an ion guide configured to guide the ions towards the ion inlet.

7. The apparatus according to claim 1, further comprising an ion source configured to provide the ions.

8. The apparatus according to claim 1, wherein the first electrode and the second electrode are mutually parallel.

9. The apparatus according to claim 1, wherein the first electrode comprises and/or is a planar electrode.

10. The apparatus according to claim 1, wherein the first electrode comprises and/or is a segmented electrode, comprising a set of segments including a first segment and a second segment, and optionally, wherein the DC power supply is configured to apply respective DC potentials to the set of segments.

11. The apparatus according to claim 1, wherein the DMS device comprises a set of grids, including a first grid, disposed in the region, optionally transverse, preferably orthogonal, to the electric field.

12. The apparatus according to claim 1, wherein the DC power supply is configured to apply respective pulsed DC potentials to the set of electrodes to provide a pulsed electric field in the region; and/or wherein the DC power supply is configured to apply respective constant DC potentials to the set of electrodes to provide a static electric field in the region.

13. The apparatus according to claim 1, wherein the apparatus comprises the analyser.

14. The apparatus according to claim 13, wherein the analyser is selected from a group consisting of: Raman spectroscopy such as surface-enhanced Raman spectroscopy, surface-enhanced Raman scattering (SERS) spectroscopy, tip enhanced Raman spectroscopy (TERS) and total internal reflection (TIR) Raman spectroscopy; mass spectrometry (MS) such as matrix-assisted laser desorption/ionization (MALDI) MS, ambient ionization MS including desorption electrospray ionization (DESI) MS, direct analysis in real time (DART) MS and liquid extraction surface analysis (LESA) MS; attenuated total reflection (ATR) and reflection-absorption (RAIR) infrared spectroscopy; X-ray photoelectron spectroscopy (XPS); Auger electron spectroscopy (AES); secondary ion mass spectrometry (SIMS); fluorescence spectroscopy; Fourier transform infrared (FTIR) spectroscopy such as attenuated total reflection (ATR) FTIR spectroscopy; atomic emission spectroscopy (AES); and atomic absorption spectroscopy (AAS).

15. A method of analysing a sample comprising analytes, the method comprising:
ionising the analytes to provide ions therefrom;
introducing the ions into a region having an electric field and a mutually transverse flow of a gas;
mutually spatially separating the ions in the flow of the gas according to their respective differential gas phase ion mobilities by the electric field;
correspondingly depositing the mutually spatially separated ions on an electrode as respective mutually spatially separated analytes; and
analysing the mutually spatially separated analytes deposited on the electrode.
